(19) United States
(12) Patent Application Publication
(10) Pub. No.: US 2026/0214228 A1
(43) Pub. Date: Jul. 23, 2026

(54) VIDEO CODING APPARATUS, VIDEO DECODING APPARATUS, VIDEO CODING METHOD, AND VIDEO DECODING METHOD

(71) Applicant: SHARP KABUSHIKI KAISHA, Sakai City, Osaka (JP)

(72) Inventors: YASUAKI TOKUMO, Sakai City, Osaka (JP); TOMOHIRO IKAI, Sakai City, Osaka (JP); YUKINOBU YASUGI, Sakai City, Osaka (JP)

(21) Appl. No.: 18/720,656

(22) PCT Filed: Dec. 12, 2022
(86) PCT No.: PCT/JP2022/045611

§ 371 Date: Jun. 16, 2024

(30) Foreign Application Priority Data
Dec. 17, 2021 (JP) 2021-204756

(51) Int. Cl. H04N 19/124; H04N 19/169; H04N 19/70

(52) U.S. Cl. CPC H04N 19/124; H04N 19/1883; H04N 19/70

(57) ABSTRACT

A video coding apparatus for coding a feature map includes a quantization unit configured to quantize the feature map, a channel pack unit configured to pack the feature map into multiple sub-channels, each including three components, and a first video coder configured to code a sub-channel of the multiple sub-channels. The first video coder codes a quantization offset value and/or a quantization scale value.

### TECHNICAL FIELD

Embodiments of the present invention relate to a video coding apparatus, a video decoding apparatus, a video coding method, and a video decoding method. This application claims priority based on JP 2021-204756 filed on Dec. 17, 2021, the contents of which are incorporated herein by reference.

### BACKGROUND ART

A video coding apparatus which generates coded data by coding a video, and a video decoding apparatus which generates decoded images by decoding the coded data are used for efficient transmission or recording of videos.

Specific video coding schemes include, for example, H. 266/Versatile Video Coding (VVC), H. 265/High Efficiency Video Coding (HEVC), and the like (NPL 1).

On the other hand, in recent years, coding schemes suitable for analysis processing using a machine, such as object detection, object segmentation, and object tracking, have been studied as well. In NPL 2, a method is disclosed in which a feature map derived from a video through deep learning or the like is coded for machine recognition.

### CITATION LIST

### Non Patent Literature

NPL 1: ITU-T Rec. H.266
NPL 2: ISO/IEC JTC 1/SC 29/WG 2 N104

### SUMMARY OF INVENTION

### Technical Problem

A problem exists in that, in a case that a feature map including many channels extracted from a video is coded and decoded using an existing video coding scheme as in NPL 1, correlation between the channels cannot be used in a method where mapping is performed within a picture. Another problem exists in that correspondence between many channels (for example, 64 channels) and pictures in the picture is unknown, and even in a case of decoding a video, the feature map is not determined and thus cannot be used for machine recognition.

An aspect of the present invention has an object to efficiently code and decode a feature map, using an existing video coding scheme as in NPL 1.

### Solution to Problem

In order to solve the problem described above, a video coding apparatus according to an aspect of the present invention is a video coding apparatus for coding a feature map. The video coding apparatus includes a quantization unit configured to quantize the feature map, a channel pack unit configured to pack the feature map into multiple sub-channels, each including three components, and a first video coder configured to code a sub-channel of the multiple sub-channels. The first video coder codes a quantization offset value and/or a quantization scale value.

In order to solve the problem described above, a video decoding apparatus according to an aspect of the present invention is a video decoding apparatus for decoding a feature map from a coding stream. The video decoding apparatus includes a first video decoder configured to decode multiple sub-channels, each including three components, from the coding stream, an inverse channel pack unit configured to reconstruct a feature map from a sub-channel of the multiple sub-channels, and an inverse quantization unit configured to inversely quantize the feature map. The first video decoder decodes a quantization offset value and/or a quantization scale value.

In order to solve the problem described above, a video coding method according to an aspect of the present invention is a video coding method of coding a feature map. The video coding method at least includes the steps of quantizing the feature map, packing the feature map into multiple sub-channels, each including three components, and coding a sub-channel of the multiple sub-channels. The coding includes coding a quantization offset value and/or a quantization scale value.

In order to solve the problem described above, a video decoding method according to an aspect of the present invention is a video decoding method of decoding a feature map from a coding stream. The video decoding method at least includes the steps of decoding multiple sub-channels, each including three components, from the coding stream, reconstructing a feature map from a sub-channel of the multiple sub-channels, and inversely quantizing the feature map. The decoding includes decoding a quantization offset value and/or a quantization scale value.

### Advantageous Effects of Invention

According to an aspect of the present invention, a feature map can be efficiently coded and decoded, with correlation of channels being taken into consideration.

### BRIEF DESCRIPTION OF DRAWINGS

FIG. 1 is a schematic diagram illustrating a configuration of an image transmission system according to the present embodiment.

FIG. 2 is a diagram illustrating configurations of a transmission apparatus equipped with a video coding apparatus and a reception apparatus equipped with a video decoding apparatus according to the present embodiment. PROD_A illustrates the transmission apparatus equipped with the video coding apparatus, and PROD_B illustrates the reception apparatus equipped with the video decoding apparatus.

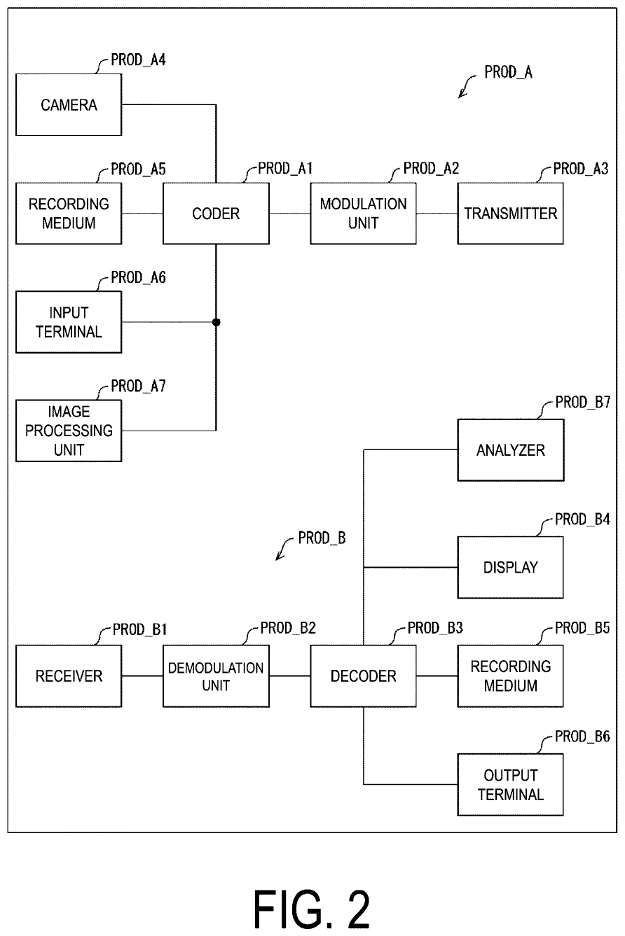

FIG. 3 is a diagram illustrating configurations of a recording apparatus equipped with the video coding apparatus and a reconstruction apparatus equipped with the video decoding apparatus according to the present embodiment. PROD_C illustrates the recording apparatus equipped with the video coding apparatus, and PROD_D illustrates the reconstruction apparatus equipped with the video decoding apparatus.

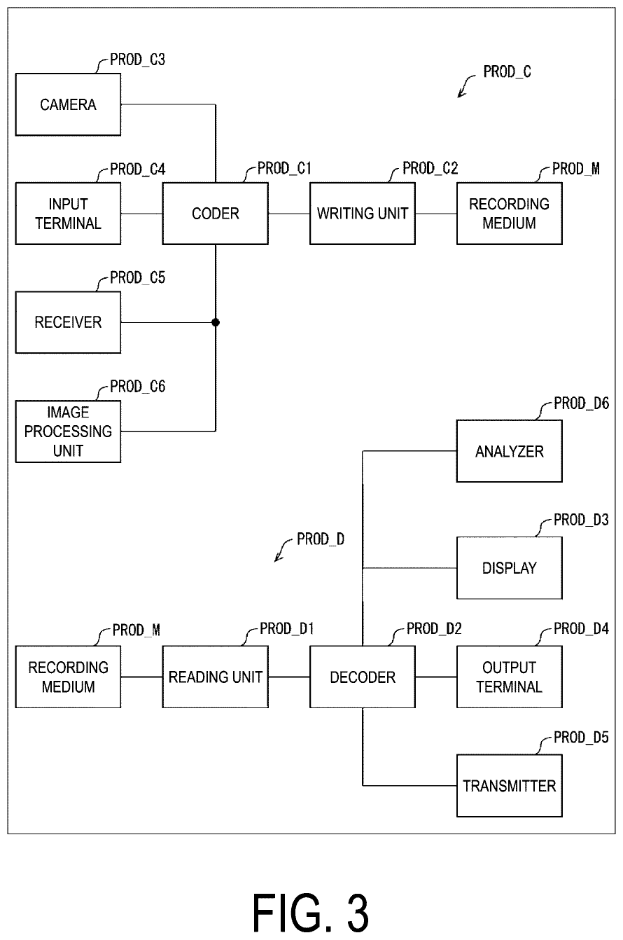

FIG. 4 is a diagram illustrating a hierarchical structure of data of a coding stream.

FIG. 5 is a functional block diagram illustrating a schematic configuration of a video coding apparatus 11 according to a first embodiment.

FIG. 6 is a diagram for illustrating input and output of a feature map extraction unit 101.

FIG. 7 is a diagram for illustrating examples of channel packs.

FIG. 8 is a diagram for illustrating examples of channel packs.

FIG. 9 is an example in which sub-channels are assigned and coded in a temporal direction.

FIG. 10 is an example in which sub-channels are assigned and hierarchically coded in a layer direction.

FIG. 11 is a functional block diagram illustrating a schematic configuration of a video decoding apparatus 31 according to the first embodiment.

FIG. 12 is a functional block diagram illustrating a schematic configuration of the video coding apparatus 11 according to a second embodiment.

FIG. 13 is a functional block diagram illustrating a schematic configuration of the video decoding apparatus 31 according to the second embodiment.

FIG. 14 is a functional block diagram illustrating a schematic configuration of the video coding apparatus 11 according to a third embodiment.

FIG. 15 is a functional block diagram illustrating a schematic configuration of the video decoding apparatus 31 according to the third embodiment.

FIG. 16 is a diagram for illustrating operation of a transform processing unit 1091.

FIG. 17 is a diagram for illustrating examples of channel packs.

FIG. 18 is a diagram illustrating examples of syntax of feature map information.

FIG. 19 is a diagram illustrating examples of syntax of a case that the feature map information is signaled using a sequence parameter set and a picture parameter set.

FIG. 20 is a diagram for illustrating an example of a channel pack using sub-pictures.

### DESCRIPTION OF EMBODIMENTS

Hereinafter, an embodiment of the present invention will be described with reference to the drawings.

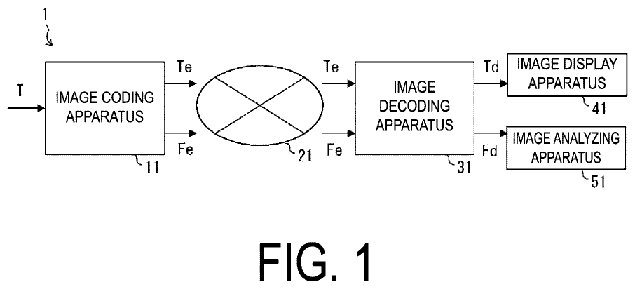

FIG. 1 is a schematic diagram illustrating a configuration of an image transmission system 1 according to the present embodiment.

The image transmission system 1 is a system in which a coding stream obtained by coding a coding target image is transmitted, the transmitted coding stream is decoded, and thus an image is displayed and/or analyzed. The image transmission system 1 includes a video coding apparatus (image coding apparatus) 11, a network 21, a video decoding apparatus (image decoding apparatus) 31, a video display apparatus (image display apparatus) 41, and a video analyzing apparatus (image analyzing apparatus) 51.

An image T is input to the video coding apparatus 11.

The network 21 transmits a coding stream Te and a coding stream Fe generated by the video coding apparatus 11 to the video decoding apparatus 31. The network 21 is the Internet, a Wide Area Network (WAN), a Local Area Network (LAN), or a combination thereof. The network 21 is not necessarily limited to a bidirectional communication network, and may be a unidirectional communication network configured to transmit broadcast waves of digital terrestrial television broadcasting, satellite broadcasting of the like. The network 21 may be replaced by a storage medium on which the coding stream Te is recorded, such as a Digital Versatile Disc (DVD) (trade name) or a Blu-ray Disc (BD) (trade name).

The video decoding apparatus 31 decodes each of the coding streams Te and the coding streams Fe transmitted from the network 21 and generates one or multiple decoded images Td and decoded feature maps Fd.

The video display apparatus 41 displays all or part of one or multiple decoded images Td generated by the video decoding apparatus 31. For example, the video display apparatus 41 includes a display device such as a liquid crystal display and an organic Electro-luminescence (EL) display. Forms of the display include a stationary type, a mobile type, an HMD type, and the like. In addition, in a case that the video decoding apparatus 31 has a high processing capability, an image having high image quality is displayed, and in a case that the video decoding apparatus has a lower processing capability, an image which does not require high processing capability and display capability is displayed.

Using one or multiple decoded feature maps Fd generated by the video decoding apparatus 31, the video analyzing apparatus 51 performs analysis processing such as object detection, object segmentation, and object tracking, and displays a part or all of analysis results on the video display apparatus 41. For example, using the feature map, the video analyzing apparatus 51 may output a list including an object ID indicating a position, a size, and a type of an object and a confidence factor.

### Structure of Coding Stream Te/Fe

Prior to the detailed description of the video coding apparatus 11 and the video decoding apparatus 31 according to the present embodiment, a data structure of the coding stream Te/Fe generated by the video coding apparatus 11 and decoded by the video decoding apparatus 31 will be described.

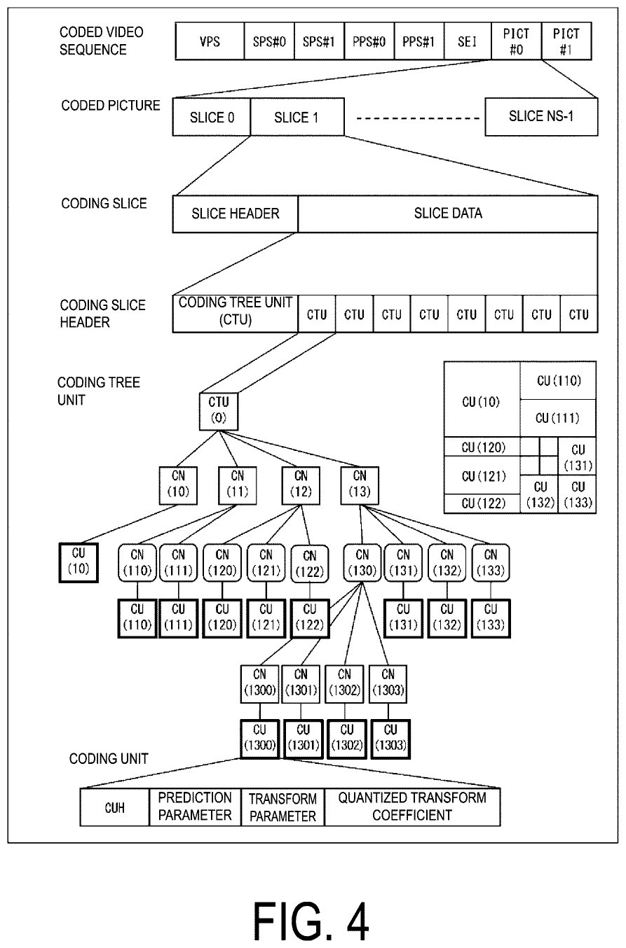

FIG. 4 is a diagram illustrating a hierarchical structure of data of the coding stream Te/Fe. The coding stream Te/Fe includes, as an example, a sequence and multiple pictures constituting the sequence. FIG. 4 is a diagram illustrating each of a coded video sequence defining a sequence SEQ, a coded picture prescribing a picture PICT, a coding slice prescribing a slice S, coding slice data prescribing slice data, a coding tree unit included in the coding slice data, and a coding unit included in the coding tree unit.

### Coded Video Sequence

In the coded video sequence, a set of data referred to by the video decoding apparatus 31 to decode a sequence SEQ to be processed is defined. As illustrated in the coded video sequence of FIG. 4, the sequence SEQ includes a Video Parameter Set, a Sequence Parameter Set SPS, a Picture Parameter Set PPS, a picture PICT, and Supplemental Enhancement Information SEI.

The video parameter set VPS defines, in a video including multiple layers, a set of coding parameters common to multiple video images and a set of coding parameters relating to multiple layers and individual layers included in the video.

In the sequence parameter sets SPSs, a set of coding parameters referred to by the video decoding apparatus 31 to decode a target sequence is defined. For example, a width and a height of a picture are defined. Further, multiple SPSs may exist. In that case, any of the multiple SPSs is selected from the PPS.

In the picture parameter sets (PPS), a set of coding parameters that the video decoding apparatus 31 refers to in order to decode each picture in the target sequence s defined. In that case, any of the multiple PPSs is selected from each picture in a target sequence.

### Coded Picture

In the coded picture, a set of data referred to by the video decoding apparatus 31 to decode a picture PICT to be processed is defined. As illustrated in the coded picture of FIG. 4, the picture PICT includes a slice 0 to a slice NS-1 (NS is the total number of slices included in the picture PICT).

### Coding Slice

In each coding slice, a set of data referred to by the video decoding apparatus 31 to decode a slice S to be processed is defined. Each slice includes a slice header and slice data as illustrated in the coding slice of FIG. 4.

The slice header includes a coding parameter group referred to by the video decoding apparatus 31 to determine a decoding method for a target slice.

Note that the slice header may include a reference to the picture parameter set PPS (pic_parameter_set_id).

### Coding Slice Data

In coding slice data, a set of data referred to by the video decoding apparatus 31 to decode slice data to be processed is defined. The slice data includes CTUs as illustrated in the coding slice header in FIG. 4. A CTU is a block having a fixed size (e.g., 64×64) constituting a slice, and may also be called a Largest Coding Unit (LCU).

### Sub-Picture

The picture may be further split into sub-pictures each having a rectangular shape. For example, it may be split into sub-pictures, with four being arrayed in the horizontal direction and four in the vertical direction. The size of each sub-picture may be a multiple of the CTU. The sub-picture is defined by a set of an integer number of vertically and horizontally consecutive tiles. The slice header may include sh_subpic_id indicating an ID of the sub-picture.

There are two types of predictions (prediction modes), which are intra prediction and inter prediction. Intra prediction refers to prediction in an identical picture, and inter prediction refers to prediction processing performed between different pictures (e.g., between pictures of different display times, and between pictures of different layer images).

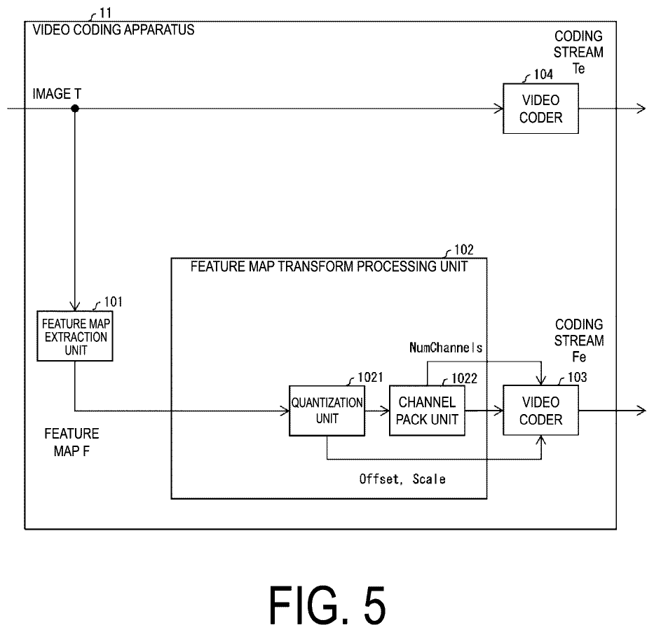

Configuration of Video Coding Apparatus According to First Embodiment FIG. 5 is a functional block diagram illustrating a schematic configuration of the video coding apparatus 11 according to a first embodiment.

The video coding apparatus 11 includes a feature map extraction unit 101, a feature map transform processing unit 102, and a video coder 103. The video coding apparatus 11 may include a video coder 104.

The feature map extraction unit 101 includes a convolutional neural network, inputs an image T including C1=3 channels (for example, RGB 3 channels), and outputs a feature map F including C2 channels.

For example, output of a first convolutional layer of Faster Region based Convolutional Neural Network (R-CNN) X101-Feature Pyramid Network (FPN), which is one of neural networks used for object detection, may be used as the feature map. In this case, the number of channels of the feature map F is C2=64.

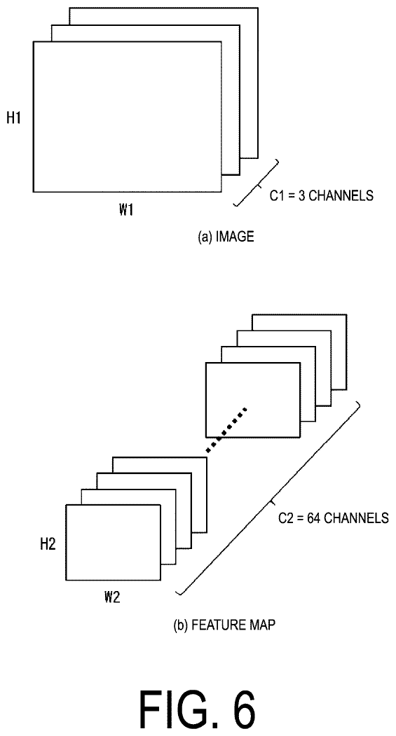

FIG. 6 is a diagram for illustrating input and output of the feature map extraction unit 101. The feature map extraction unit 101 inputs the image T of W1 (width)×H1 (height)×C1 (number of channels), and outputs the feature map F of W2 (width)×H2 (height)×C2 (number of channels) via a convolutional layer, an activation function, a pooling layer, or the like. Here, each value of the image T may be an 8-bit integer, and each value of the feature map F may be a 16-bit fixed-point number. It may be a 32-bit floating-point number. The feature map F is an image of the width W2, the height H2, and the number C2 of channels.

The feature map transform processing unit 102 includes a quantization unit 1021 and a channel pack unit 1022. The feature map transform processing unit 102 quantizes the video/image of the feature map F output by the feature map extraction unit 101. The feature map transform processing unit 102 makes split and remap (hereinafter, pack) into a set of multiple videos/images (hereinafter, sub-channels) and then outputs the packed video/image. Note that the sub-channel is short for a sub-set channel (sub-set of channels).

The quantization unit 1021 quantizes the feature map F with an integer value (for example, a 10-bit integer, bitDepth=10), and outputs a quantized feature map qF.

The quantized feature map qF is represented by the following equation.

$$qF = Offset + Round ( F / Scale )$$

Here, Round (a) is a function that returns an integer value of a, and is defined as follows.
F: Feature map (32-bit floating-point number)
qF: Quantized feature map (for example, 10-bit integer)
Offset: Quantization offset value (for example, 10-bit integer)
Scale: Quantization scale value
The quantization unit 1021 signals Offset and Scale to the video coder 103.
“/” represents integer division in which numbers after the decimal point are truncated toward zero. “÷” represents division in which truncation or rounding is not performed.

### Configuration of Assigning to Layer

The channel pack unit 1022 assigns (packs) qF to images (sub-channels) subSamples of multiple videos including three components (for example, luminance Y and chrominances U and V) and then outputs the images. For example, the channel pack unit 1022 performs the following processing on the feature value qF of the channels of IDs indicated by c=0 . . . . C2-1, and derives an i-th (i=0 . . . (C2+2)/3) image/video (sub-channels) identified with subChannelID. Here, x=y . . . z indicates that an integer value x between an integer value y and an integer value z is derived in order and processing is performed.

c = 0
do {
subChannelID = c/3
subSamples[subChannelID][y][x][0] = qF[y][x][c]; c = c + 1
subSamples[subChannelID][y][x][1] = qF[y][x][c]; c = c + 1
subSamples[subChannelID][y][x][2] = qF[y][x][c]; c = c + 1
} while (c < C2)

The following may be employed.

$$subChannelID = c / numComps$$

$$subSamples [ subChanne [ ID ] [ y ] [ x ] [ c \% numComps ] = qF [ y ] [ x ] [ c ]$$

$$c = 0 … C 2 - 1. numComps = 3 may hold .$$

Here, “%” indicates modulo (MOD) operation.

Here, subSamples is an array of images indicated by sub-channel IDs (subChannelID). Note that the channel pack unit 1022 may determine whether there is a channel of the feature map, and in a case that there is not a channel of the feature map, the channel pack unit 1022 may assign a prescribed value FillVal, for example, 1<< (bitDepth-1), depending on bit-depth bitDepth of the image. In a case of 10 bits, FillVal may be 512.

$$subChannelID = c / numComps$$

$$subSamples [ subChannelID ] [ y ] [ x ] [ 0 ] = c >= C 2 ? FillVal : qF [ y ] [ x ] [ c ] ;$$

$$c = c + 1$$

$$subSamples [ subChannelID ] [ y ] [ x ] [ 1 ] = c >= C 2 ? FillVal : qF [ y ] [ x ] [ c ] ;$$

$$c = c + 1$$

$$subSamples [ subChannelID ] [ y ] [ x ] [ 2 ] = c >= C 2 ? FillVal : qF [ y ] [ x ] [ c ] ;$$

$$c = c + 1$$

$$Here , y = 0 … H 2 - 1 , and x = 0 … W 2 - 1. numComps = 3.$$

Derivation may be performed as follows.

$$subSamples [ subChannelID ] [ y ] [ x ] [ 0 ] = qF [ y ] [ x ] [ c / 3 ] ;$$

$$subSamples [ subChannelID ] [ y ] [ x ] [ 1 ] = qF [ y ] [ x ] [ c / 3 + 1 ] ;$$

$$subSamples [ subChannelID ] [ y ] [ x ] [ 2 ] = qF [ y ] [ x ] [ c / 3 + 2 ] ; c = c + 3$$

Alternatively, derivation may be performed as follows.

$$subSamples [ subChannelID ] [ y ] [ x ] [ 0 ] = qF [ y ] [ x ] [ 3 * subChannelID ] ;$$

$$subSamples [ subChannelID ] [ y ] [ x ] [ 1 ] = qF [ y ] [ x ] [ 3 * subChannelID + 1 ] ;$$

$$subSamples [ subChannelID ] [ y ] [ x ] [ 2 ] = qF [ y ] [ x ] [ 3 * subChannelID + 2 ] ;$$

$$Here , subChannelID = 0 … numSubChannels - 1.$$

In a case that the number C2 of channels of the feature map is represented by numChannels, the channel pack unit 1022 derives the number numSubChannels of sub-channels according to the following, depending on the number numComps of components of the image.

$$numSubChannels = Ceil ( numChannels \div numComps )$$

numComps may be 3 (in cases of 4:2:0 and 4:4:4). In a case of 4:0:0, numComps=1.

Here, Ceil (a) is a function that returns the smallest integer that is equal to or greater than a. Derivation may be performed as follows, using division in which numbers after the decimal point are truncated.

$$numSubChannels = ( numChannels + numComps - 1 ) / numComps$$

In a case that the feature map is assigned to sub-pictures as well as components of the image, derivation is performed as follows, using the number numSubpics of sub-pictures.

$$numSubChannels = ( numChannels + numComps * numSubpics - 1 ) / numComps * numSubpics )$$

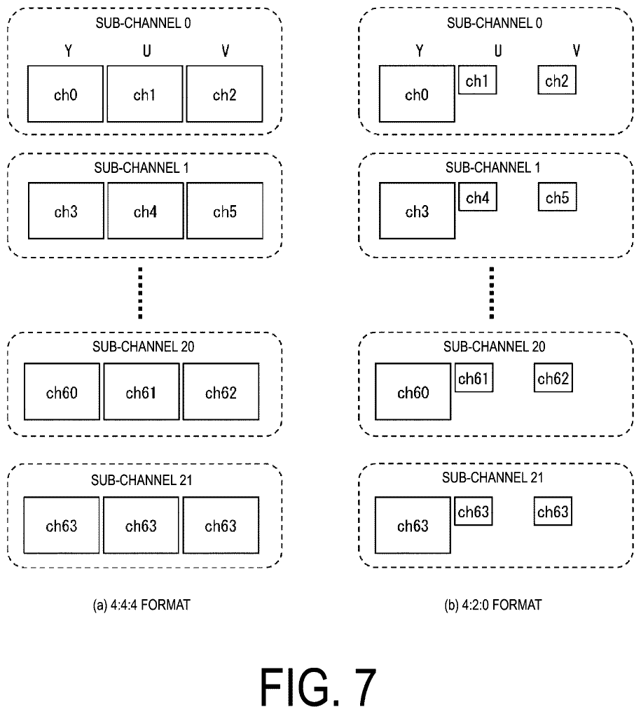

FIG. 7 is a diagram for illustrating examples of channel packs.

FIG. 7(a) is an example in which the channels of the feature map are assigned to multiple 4:4:4 format videos (for example, format corresponding to sps_chroma_format_idc=3 in H.266/VVC and H.265/HEVC). numChannels is 64. The number numSubChannels of sub-channels is numSubChannels=Ceil (64/3)=22.

The channel pack unit 1022 may scan and assign the channels (ch0, ch1, . . . , ch63) of the feature map so that order of the channels is as follows: an outer loop is in order of sub-channels, and an inner loop is in order of components. In other words, ch0 is assigned to component Y of sub-channel 0, ch1 is assigned to component U of sub-channel 0, ch2 is assigned to component V of sub-channel 0, ch3 is assigned to component Y of sub-channel 1, ch4 is assigned to component U of sub-channel 1, ch5 is assigned to component V of sub-channel 1, and so on. In last sub-channel 21, there is not a feature map to be assigned to components U and V, and thus channel ch63 of the feature map assigned to component Y is copied. Alternatively, it may be filled with the above-described prescribed pixel value FillVal.

FIG. 7(b) is an example in which the channels of the feature map are assigned to multiple 4:2:0 format videos (for example, format corresponding to sps_chroma_format_idc=1 in H.266/VVC and H.265/HEVC). The channel pack unit 1022 downsamples the feature map to ½ in both of the horizontal direction and the vertical direction and assigns to components U and V.

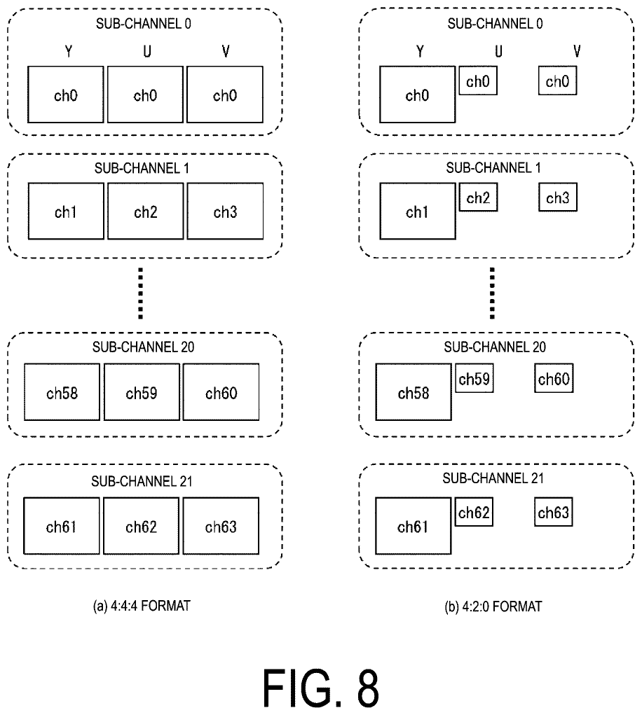

FIG. 8 is a diagram for illustrating examples of channel packs.

FIG. 8(a) is an example in which the channels of the feature map are assigned to multiple 4:4:4 format videos. The channel pack unit 1022 may scan and assign the channels (ch63, ch62, . . . , ch0) of the feature map so that order of the channels is as follows: an outer loop is in reverse order of sub-channels, and an inner loop is in reverse order of components. In other words, ch63 is assigned to component V of sub-channel 21, ch62 is assigned to component U of sub-channel 21, ch61 is assigned to a Y channel of sub-channel 21, ch60 is assigned to component V of sub-channel 20, ch59 is assigned to component U of sub-channel 20, ch58 is assigned to component Y of sub-channel 20, and so on. In first sub-channel 0, there is not a feature map to be assigned to components U and Y, and thus channel ch0 of the feature map assigned to component V is copied. Alternatively, it may be filled with the above-described prescribed pixel value FillVal.

FIG. 8(b) is an example in which the channels of the feature map are assigned to multiple 4:2:0 format videos. The channel pack unit 1022 downsamples the feature map to ½ in both of the horizontal direction and the vertical direction and assigns to components U and V. For example, the image of the feature map of the channels of channelID % 3==1 and 2 is downsampled to ½, with the image of the feature map of the channel of channelID % 3==0 being as it is.

$$subSamples [ subChannelID ] [ y ] [ x ] [ 0 ] = qF [ y ] [ x ] [ c ] ; c = c + 1$$

$$subSamples [ subChannelID ] [ y >> 1 ] [ x >> 1 ] [ 1 ] = qF [ y ] [ x ] [ c ] ; c = c + 1$$

$$subSamples [ subChannelID ] [ y >> 1 ] [ x >> 1 ] [ 2 ] = qF [ y ] [ x ] [ c ] ; c = c + 1$$

### Configuration of Assigning to Sub-Picture

The channel pack unit 1022 derives the number numSubChannels of sub-channels from the number numChannels of channels and the number numSubpics of sub-pictures.

$$numSubChannels = Ceil ( numChannels \div ( numSubpics * numComps ) )$$

The channel pack unit 1022 derives an image including multiple sub-pictures from the feature map qF as follows.

For example, the channel pack unit 1022 assigns the feature map qF to a pixel value sub Samples [y][x][c] of an image including sub-pictures in which the number of sub-pictures in the horizontal direction is numSubpicsX and the number of sub-pictures in the vertical direction is numSubpics Y as follows.

$$s = subpic\_id = ( c / numComps ) \% ( numSubpicX * numSubPicsY )$$

$$subSamples [ subChannelID ] [ s ] [ y ] [ x ] [ 0 ] = qF [ y ] [ x ] [ c ] ; c = c + 1$$

$$subSamples [ subChannelID ] [ s ] [ y ] [ x ] [ 1 ] = qF [ y ] [ x ] [ c ] ; c = c + 1$$

$$subSamples [ subChannelID ] [ s ] [ y ] [ x ] [ 2 ] = qF [ y ] [ x ] [ c ] ; c = c + 1$$

Here, y=0 . . . . H2-1, x=0 . . . . W2-1, c=0 . . . . C2-1, and numComps=3. Scanning is performed between subpic_id=0 . . . numSubChannels-1.

In the following, another example of assigning to the sub-pictures will also be described.

### Configuration 1 of Assigning to Sub-Picture and Layer

The channels (sub-channels) of the feature map may be assigned to a video including multiple sub-pictures. The channel pack unit 1022 derives a video in which a specific channel of the feature map is assigned to a specific channel of a sub-picture. For example, in a case that the number of sub-pictures mapped in one picture is represented by numSubpics, the channel pack unit 1022 generates images of y=0 . . . . H2-1, x=0 . . . . W2-1, and c=0 . . . . C2-1.

$$s = subpic\_id = ( c / 3 ) \% numSubpics$$

$$subChannelID = ( c / 3 ) / numSubpics$$

$$subSamples [ subChannelID ] [ s ] [ y ] [ x ] [ 0 ] = qF [ y ] [ x ] [ c ] ; c = c + 1$$

$$subSamples [ subChannelID ] [ s ] [ y ] [ x ] [ 1 ] = qF [ y ] [ x ] [ c ] ; c = c + 1$$

$$subSamples [ subChannelID ] [ s ] [ y ] [ x ] [ 2 ] = qF [ y ] [ x ] [ c ] ; c = c + 1$$

Here, subSamples is an array of images indicated by indicated sub-channel IDs (subChannelID). Note that the channel pack unit 1022 may determine whether there is a channel of the feature map, and in a case that there is not a channel of the feature map, the channel pack unit 1022 may assign the prescribed value FillVal. A header coder 1031 of the video coder 103 to be described later may assign subChannelID to a layer ID (layer_id) and code as coded data.

$$s = subpic\_id = ( c / 3 ) \% numSubpics$$

$$subChannelID = ( c / 3 ) / numSubpics$$

$$subSamples [ subChannelID ] [ s ] [ y ] [ x ] [ 0 ] = c >= C 2 ? FillVal : qF [ y ] [ x ] [ c ] ;$$

$$c = c + 1$$

$$subSamples [ subChannelID ] [ s ] [ y ] [ x ] [ 1 ] = c >= C 2 ? FillVal : qF [ y ] [ x ] c ] ;$$

$$c = c + 1$$

$$subSamples [ subChannelID ] [ s ] [ y ] [ x ] [ 2 ] = c >= C 2 ? FillVal : qF [ y ] [ x ] [ c ] ;$$

$$c = c + 1$$

### Configuration 2 of Assigning to Sub-Picture

The channel pack unit 1022 may assign a video of each channel of the feature map to the sub-pictures. For example, the feature map of 64 channels can be assigned to 4×16 sub-pictures, with 4 in the horizontal direction and 16 in the vertical direction, in a video of 4:0:0 using sub-pictures.

For example, the channel pack unit 1022 assigns the value qF of the feature map to the pixel value subSamples [y][x][c] of a video including sub-pictures in which the number of sub-pictures in the horizontal direction is numSubpicsX and the number of sub-pictures in the vertical direction is numSubpicsY as follows.

$$sx = c \% numSubpicsX$$

$$sy = c / numSubpicsX$$

$$sunSamples [ y + sy * subPicH ] [ x + sx * subPicW ] [ 0 ] = qF [ y ] [ x ] [ c ] ;$$

$$c = c + 1$$

Here, subPicW and subPicH are the width and the height of the sub-picture, and subPicH=H2/numSubpicsY and subPicW=W2/numSubpicsX may hold. Here, y=0 . . . . H2-1, x=0 . . . . W2-1, and c=0 . . . . C2-1. Scanning is performed between sx=0 . . . numSubpicsX-1 and sy=0 . . . numSubpicsY-1.

### Configuration 2 of Assigning to Layer and Sub-Picture

Furthermore, the channel pack unit 1022 may assign a video of each channel of the feature map to the sub-pictures of multiple videos. For example, in a case that the number of sub-pictures in the horizontal direction is represented by numSubpicsX and the number of sub-pictures in the vertical direction is represented by numSubpicsY, the channel pack unit 1022 performs the following processing on y=0 . . . . H2-1, x=0 . . . . W2-1, c=0 . . . . C2-1, sx=0 . . . numSubpicsX-1, and sy=0 . . . numSubpicsY-1, and generates an i-th (i=0 . . . ((C2+ (3*(numSubpicsX*numSubpicsY)-1))/(3*(numSubpicsX*numSubpicsY))) image.

$$subChannelID = ( c / 3 ) / ( numSubpicsX * numSubpicsY )$$

$$sx = ( c / 3 ) \% numSubpicsX$$

$$sy = ( c / 3 ) / numSubpicsX$$

$$subSamples [ subChannelID ] [ y + sy * subPicH ] [ x + sx * subPicW ] [ 0 ] = qF [ y ] [ x ] [ c ] ; c = c + 1$$

$$subSamples [ subChannelID ] [ y + sy * subPicH ] [ x + sx * subPicW ] [ 1 ] = qF [ y ] [ x ] [ c ] ; c = c + 1$$

$$subSamples [ subChannelID ] [ y + sy * subPicH ] [ x + sx * subPicW ] [ 2 ] = qF [ y ] [ x ] [ c ] ; c = c + 1$$

Here, subSamples is an array of images indicated by indicated sub-channel IDs (subChannelID). Note that the channel pack unit 1022 may determine whether there is a channel of the feature map, and in a case that there is not a channel of the feature map, the channel pack unit 1022 may assign the prescribed value, for example, FillVal.

$$subChannelID = ( c / 3 ) / ( numSubpicsX * numSubpicsY )$$

$$subSamples [ subChannelID ] [ y + sy * subPicH ] [ x + sx * subPicW ] [ 0 ] = c >= C 2 ? FillVal : qF [ y ] [ x ] [ c ] ; c = c + 1$$

$$subSamples [ subChannelID ] [ y + sy * subPicH ] [ x + sx * subPicW ] [ 1 ] = c >= C 2 ? FillVal : qF [ y ] [ x ] [ c ] ; c = c + 1$$

$$subSamples [ subChannelID ] [ y + sy * subPicH ] [ x + sx * subPicW ] [ 2 ] = c >= C 2 ? FillVal : qF [ y ] [ x ] [ c ] ; c = c + 1$$

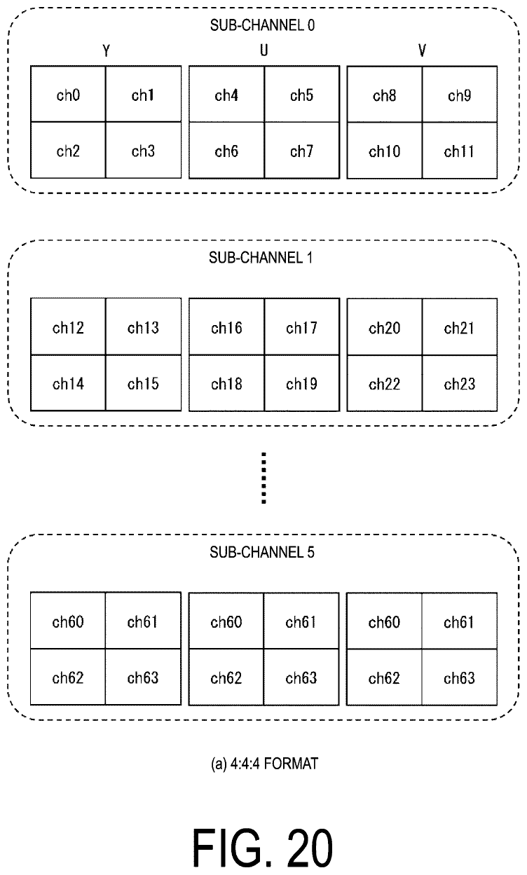

FIG. 20 is a diagram for illustrating an example of a channel pack using sub-pictures.

FIG. 20(a) is an example in which the channels of the feature map are assigned to multiple 4:4:4 format videos. numChannels is 64. numSubpics is 4. numSubChannels is num SubChannels=Ceil (NumChannels/(NumSubPictures*3))=6.

The channel pack unit 1022 may scan and assign the channels (ch0, ch1, . . . , ch63) of the feature map so that order of the channels is as follows: a first loop is in order of sub-channels, a second loop is in order of components, and a third loop is in order of sub-pictures. In other words, ch0 is assigned to sub-picture 0 of component Y of sub-channel 0, ch1 is assigned to sub-picture 1 of component Y of sub-channel 0, ch2 is assigned to sub-picture 2 of component Y of sub-channel 0, ch3 is assigned to sub-picture 3 of component Y of sub-channel 0, ch4 is assigned to sub-picture 0 of component U of sub-channel 0, ch5 is assigned to sub-picture 1 of component U of sub-channel 0, ch6 is assigned to sub-picture 2 of component U of sub-channel 0, ch7 is assigned to sub-picture 3 of component U of sub-channel 0, and so on. In last sub-channel 5, there is not a feature map to be assigned to components U and V, and thus channels ch60, ch61, ch62, and ch63 of the feature map assigned to component Y are copied. Alternatively, it may be filled with the above-described prescribed pixel value FillVal.

In a case that the channels of the feature map are assigned to multiple 4:2:0 format videos, the channel pack unit 1022 downsamples the feature map to ½ in both of the horizontal direction and the vertical direction and assigns to components U and V.

The channel pack unit 1022 signals the number numChannels of channels and the number numSubpics of sub-pictures of the feature map and the like to the video coder 103.

Although the number of components of an image is three in the example described above, any number numComps of components may be used (the same holds hereinafter).

The channel pack unit 1022 assigns (packs) qF to multiple images subSamples (sub-channels) including numComps components and then outputs. For example, the channel pack unit 1022 performs the following processing on the image qF of the feature value of the channels of IDs indicated by c=0 . . . . C2-1, and derives an i-th (i=0 . . . (C2+numComps-1)/numComps) image/video (sub-channels) identified with subChannelID.

```
      c = 0
      do {
      subChannelID = c/numComps
      subSamples[y][x][c%numComps] of the image indicated
by subChannelID = qF[y ][x][c]; c = c + 1
      } while (c < C2)
```

The video coder 103 codes the sub-channel output from the channel pack unit 1022, and outputs as the coding stream Fe. As coding schemes, VVC/H.266, HEVC/H.265, and the like can be used. The video coder 103 includes the header coder 1031 that codes the layer ID and codes information of sub-pictures, and a prediction image generation unit 1032 that generates an inter prediction image.

The header coder 1031 may code the number num Subpics of sub-pictures-1 to sps_num_subpics_minus1, and a flag sps_independent_subpics_flag indicating that the sub-pictures are independent. A top left position (sps_subpic_ctu_top_left_x[i] and sps_subpic_ctu_top_left_y[i]), width sps_subpic_width_minus1[i], and height sps_subpic_height_minus1[i] of an i-th sub-picture may be coded. Furthermore, sps_subpic_treated_as_pic_flag[i] indicating whether it is independent for each sub-picture unit may be coded. In a case that the feature map is assigned to sub-pictures and coded, the header coder 1031 performs coding of sps_independent_subpics_flag=1 or a specific sub-picture i as sps_independent_subpics_flag[i]=1.

In a case of referring to a picture different from a target sub-picture and a case that sps_independent_subpics_flag=1 or the specific sub-picture i is sps_independent_subpics_flag[i] ==1, the prediction image generation unit 1032 pads pixels at a sub-picture boundary and does not refer to pixels of other sub-pictures. Specifically, as in the following, the prediction image generation unit 1031 clips and restricts X coordinates xInt of a reference pixel using a left boundary position SubpicLeftBoundaryPos and a right boundary position SubpicRightBoundaryPos of the sub-picture as follows. Y coordinates yInt of the reference pixel is clipped and restricted as follows, using a top boundary position SubpicTopBoundaryPos and a bottom boundary position SubpicBottomBoundaryPos of the sub-picture. The prediction image generation unit 1032 generates a prediction image through filter processing and the like, using the reference pixel at the clipped position.

$$xInt = Clip 3 ( SubpicLeftBoundaryPos , SubpicRightBoundaryPos , xIntL )$$

$$yInt = Clip 3 ( SubpicTopBoundaryPos , SubpicBotBoundaryPos , yIntL )$$

Here, Clip3 (a, b, c) is a function that clips c to a value of a to b, and is a function that returns a in a case that c<a, returns b in a case that c>b, and returns c in other cases (it should be noted that a <=b).

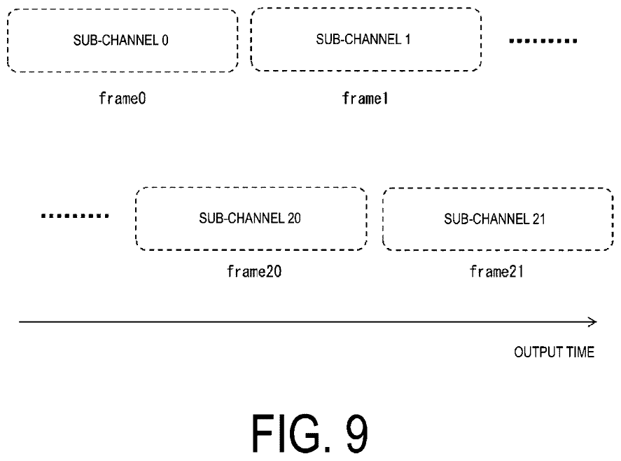

FIG. 9 is an example in which the sub-channels are assigned and coded in a temporal direction. Sub-channel 0 is assigned to frame frame 0 and coded, sub-channel 1 is assigned to frame 1 and coded, . . . , sub-channel 20 is assigned to frame 20 and coded, and sub-channel 21 is assigned to frame 21 and coded. The number numFrames of frames is numFrames=num SubChannels=22. The number numLayers of layers is numLayers=1.

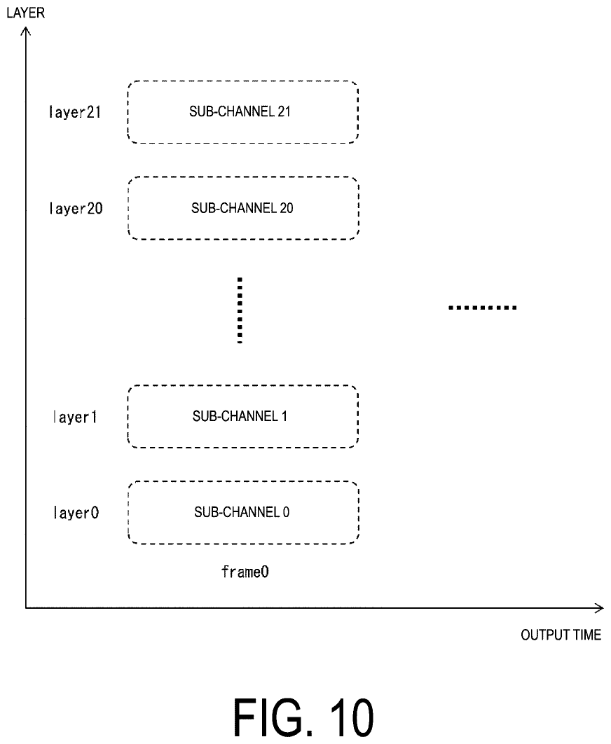

FIG. 10 is an example in which the sub-channels are assigned and hierarchically coded in a layer direction. Sub-channel 0 is assigned to layer 0 of frame 0 and hierarchically coded, sub-channel 1 is assigned to layer 1 of frame 0 and hierarchically coded, . . . , sub-channel 20 is assigned to layer 20 of frame 0 and hierarchically coded, and sub-channel 21 is assigned to layer 21 of frame 0 and hierarchically coded. numFrames=1. numLayers=num SubChannels=22.

The video coder 103 codes feature map information including Offset and Scale signaled by the quantization unit 1021 and numChannels signaled by the channel pack unit 1022 as signaling data (for example, supplemental enhancement information SEI), and outputs as the coding stream Fe. The signaling data is not limited to the SEI being attached data of the video, and may be, for example, syntax of a transmission format, such as the ISO base media file format (ISOBMFF), DASH, MMT, and RTP.

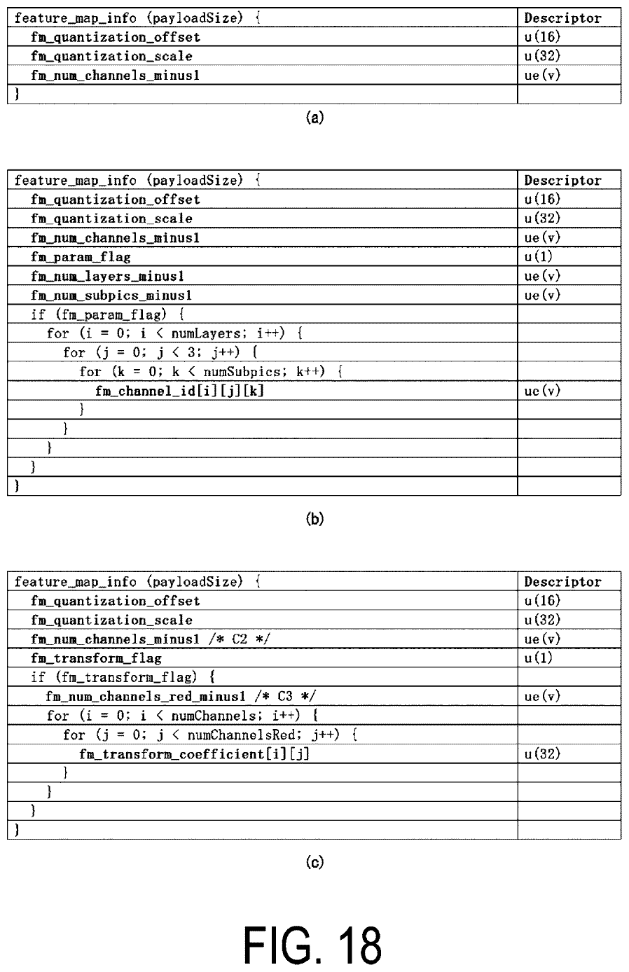

FIG. 18(a) is a diagram illustrating an example of syntax feature_map_info( ) of the feature map information. Semantics of each field is as follows.
fm_quantization_offset: Quantization offset value Offset
fm_quantization_scale: Quantization scale value Scale
fm_num_channels_minus1: fm_num_channels_minus1+1 indicates the number numChannels of channels of the feature map.

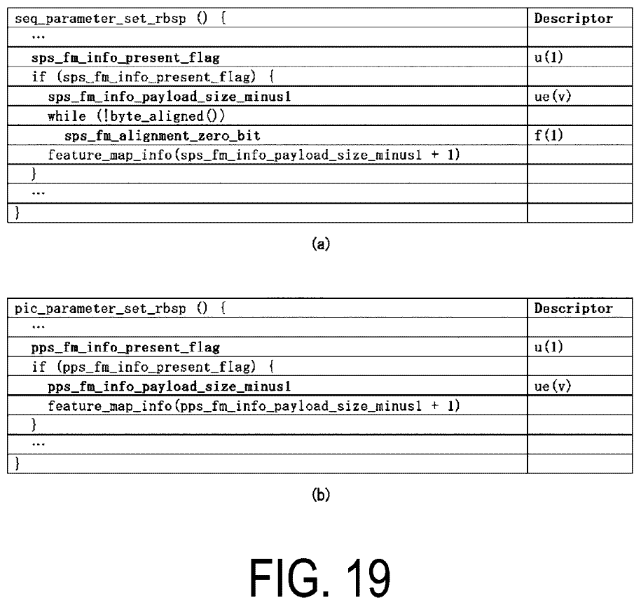

Alternatively, the feature map information may be signaled by the sequence parameter set SPS. FIG. 19(a) is an example of syntax in a case that the feature map information is signaled by the sequence parameter set SPS. Semantics of each field is as follows.
sps_fm_info_present_flag: 1 in a case that there is feature_map_info( ) and 0 in a case that there is not.
sps_fm_info_payload_size_minus1: sps_fm_info_payload_size_minus1+1 indicates the size of feature_map_info( )
sps_fm_alignment_zero_bit: 1-bit value 1.

Alternatively, the feature map information may be signaled by the picture parameter set PPS. FIG. 19(b) is an example of syntax in a case of signaling with the picture parameter set PPS. Semantics of each field is as follows.
pps_fm_info_present_flag: 1 in a case that there is feature_map_info( ) 0 in a case that there is not.
pps_fm_info_payload_size_minus1: pps_fm_info_payload_size_minus1+1 indicates the size of feature_map_info( )

The video coder 103 may code information indicating correspondence between a feature map image and a channel ID (for example, a channel number) as the supplemental enhancement information SEI.

FIG. 18(b) is a diagram illustrating an example of the syntax feature_map_info( ) of the feature map information. Semantics of each field is as follows.

fm_param_flag: In a case of 1, a relationship between each component of each sub-picture of each layer and the feature map is coded. For example, the channel ID of the feature map corresponding to each component of each sub-picture of each layer is coded. In a case of 0, the relationship is derived based on a predetermined treatment method without coding the channel ID.
fm_num_layers_minus1: fm_num_layers_minus1+1 indicates the number of layers of the image/video used for transmission of the feature map.
fm_num_subpics_minus1: fm_num_subpics_minus1+1 indicates the number of sub-pictures of the image/video used for transmission of the feature map.
fm_channel_id[i][j][k]: Correspondence information indicating the channel ID of the feature map stored in a j-th component of a k-th sub-picture of an i-th layer.

The video coder 104 codes the image T, and outputs as the coding stream Te. As coding schemes, VVC/H.266, HEVC/H.265, and the like can be used, similarly to the video coder 103.

### Configuration of Image Decoding Apparatus According to First Embodiment

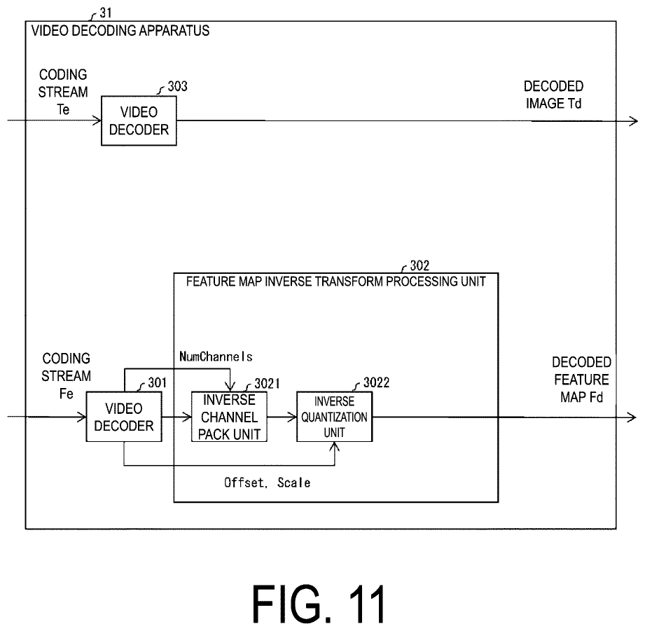

FIG. 11 is a functional block diagram illustrating a schematic configuration of the video decoding apparatus 31 according to the first embodiment.

The video decoding apparatus 31 includes a video decoder 301, a feature map inverse transform processing unit 302, and a video decoder 303.

The video decoder 301 has a function of decoding the coding stream that has been coded with VVC/H.266, HEVC/H.265, or the like, and decodes the coding stream Fe and outputs an image/video (packed sub-channels) in which the feature map is mapped to the feature map inverse transform processing unit 302. The sub-channels are the image/video illustrated in FIG. 7 or FIG. 8, for example. A header decoder 3011 of the video decoder 301 to be described later may assign subChannelID to the layer ID and decode from the coded data.

The video decoder 301 decodes the feature map supplemental enhancement information SEI included in the coding stream Fe, derives the feature map information including the quantization offset value Offset, the quantization scale value Scale, the number numChannels of channels of the feature map, and the like, and signals to the feature map inverse transform processing unit 302.

$$Offset = fm\_quantization \_offset$$

$$Scale = fm\_ quantization\_scale$$

$$numChannels = fm\_ num\_channels \_minus1 + 1$$

$$numLayers = fm\_ num\_layers \_minus1 + 1$$

$$numSubpics = fm\_num \_subpics \_minus1 + 1$$

Alternatively, these values may be derived by decoding the sequence parameter set SPS illustrated in FIG. 19(a).

Alternatively, these values may be derived by decoding the picture parameter set PPS illustrated in FIG. 19(b).

The video decoder 301 includes the header decoder 3011 that decodes the layer ID (layer_id) of the video from a NAL unit header of the coded data and decodes information of the sub-pictures constituting the video. NAL is an abbreviation for Network Abstraction Layer. The NAL includes a NAL unit header and a NAL unit data, and the NAL unit header includes the parameter set, the slice data, and the like. The NAL unit header may include a NAL unit type and a temporal ID, and indicates an abstract type of the coded data.

The feature map inverse transform processing unit 302 includes an inverse channel pack unit 3021 and an inverse quantization unit 3022. The feature map inverse transform processing unit 302 outputs a feature map FdBase (or a difference feature map FdResi).

The inverse channel pack unit 3021 reconstructs the feature map FdBase (or the difference feature map FdResi) from multiple sub-channels including three components (for example, luminance Y and chrominances U and V).

For example, the inverse channel pack unit 3021 performs processing given in the following pseudocode on the image subSamples indicated by subChannelID decoded from the video decoder 301. The following processing is performed on y=0 . . . . H2-1, x=0 . . . . W2-1, and c=0 . . . . C2-1, and qF is generated from i-th subSamples (i=0 . . . (C2+2)/3).

```
numComps=3
  for (c = 0; c < C2; c++) {
    for (y = 0; y < H2; y++) {
      for (x = 0; x < W2; x++) {
        qF[y][x][c] = subSamples[y][x][c%numComps]
    }
  }
}
```

Note that, for subChannelID, layer_id (subChannelID=layer_id) derived from the coded data may be used, or an ID assigned to the video/image of the sub-channel derived from the transmission format may be used.

In a case of using the sub-pictures, the inverse channel pack unit 3021 performs processing of reconstructing qF from subSamples given in the following pseudocode on the image sub Samples of subChannelID decoded from the video decoder 301. The following processing is performed on y=0 . . . . H2-1, x=0 . . . . W2-1, c=0 . . . . C2-1, and s=0 . . . numSubpics-1, and an i-th (i=0 . . . (C2+2)/3) image is generated.

```
numComps=3
  for (c = 0; c < C2; c++) {
    for (y = 0; y < H2; y++) {
      for (x = 0; x < W2; x++) {
        for (s = 0; s < numSubpics; s++) {
            qF[y][x][c] = subSamples[s][y][x][c%numComps]
      }
    }
  }
}
```

In a case of using the sub-pictures, the inverse channel pack unit 3021 performs processing of reconstructing qF from subSamples given in the following pseudocode on the image subSamples of subChannelID decoded from the video decoder 301. The following processing is performed on y=0 . . . . H2-1, x=0 . . . . W2-1, c=0 . . . . C2-1, sy=0 . . . numSubpicsY-1, and sx=0 . . . numSubpicsX-1, and an i-th (i=0 . . . (C2+2)/3) image is generated.

```
numComps=3
  for (c = 0; c < C2; c++) {
    for (y = 0; y < H2; y++) {
      for (x = 0; x < W2; x++) {
        for (sy = 0; sy < numSubpicsY; sy++) {
          for (sx = 0; sx < numSubpicsX; sx++) {
              qF[y][x][c] = subSamples[y+sy*subPicH][x+
sx*subPicW][c%numComps]
        }
      }
    }
  }
}
```

Derivation of Feature Map Using Correspondence Information fm_channel_id and Layer

The inverse channel pack unit 3021 may map data stored in a component comp_id (0, 1, 2) included in a layer of layer_id (0 . . . numLayers-1) to feature data of a channel indicated by fm_channel_id [layer_id][comp_id][0]. The feature map qF may be derived using fm_channel_id.

```
numComps=3
  for (c = 0; c < C2; c++) {
    for (y = 0; y < H2; y++) {
      for (x = 0; x < W2; x++) {
          subChannelID = layer_id
          channel_id = fm_channel_id[subChannelID][c%numComps][0]
          qF[y][x][channel_id] = subChannelID@subSamples[y][x][c%numComps]
    }
  }
}
```

The inverse channel pack unit 3021 may perform the above processing in a case that fm_param_flag is 1.

In a case that fm_param_flag=0 and fm_channel_id is not present, the header decoder 3031 may derive the correspondence information fm_channel_id from the layer of subChannelID in c=0 . . . . C2-1.

$$subChannelID = c / 3$$

$$fm\_channel \_id [ subChannelID ] [ c \% 3 ] [ 0 ] = c$$

Derivation of Feature Map Using Correspondence Information fm_channel_id and Sub-Layer

The inverse channel pack unit 3021 may map data stored in a sub-picture to data of a channel fm_channel_id [0][comp_id][subpic_id] of the feature map.

```
numComps=3
  for (c = 0; c < C2; c++) {
    for (y = 0; y < H2; y++) {
      for (x = 0; x < W2; x++) {
          sx = (c/numComps) % numSubpicsX
          sy = (c/numComps) / numSubpicsX
          subpic_id = sysnumSubpicsX+sx
          channel_id = fm_channel_id[0][c%3][subpic_id]
          qF[y][x][channel_id] = subSamples[y+sy*subPicH][x+
sx*subPicW][c%numComps]
    }
  }
}
```

The inverse channel pack unit 3021 may perform the above processing in a case that fm_param_flag is 1.

In a case that fm_param_flag=0 and fm_channel_id is not present, the header decoder 3031 may derive the correspondence information fm_channel_id from the sub-picture ID subpic_id in c=0 . . . . C2-1.

$$numComps = 3$$

$$sx = ( c / numComps ) \% numSubpicsX$$

$$sy = ( c / numComps ) / numSubpicsX$$

$$subpic\_id = sy * numSubpicsX + sx$$

$$fm\_channel \_id [ 0 ] [ c \% numComps ] [ subpic\_id ] = c$$

Derivation of Feature Map Using Correspondence Information fm_channel_id, Layer, and Sub-Layer

For example, in a case that fm_param_flag is 1, the inverse channel pack unit 3021 may map data stored in a sub-picture to data of a channel fm_channel_id [layer_id][comp_id][subpic_id] of the feature map.

```
numComps = 3
  for (c = 0; c < C2; c++) {
    for (y = 0; y < H2; y++) {
      for (x = 0; x < W2; x++) {
        subChannelID = layer_id
        sx = (c/numComps/numLayers) % numSubpicsX
        sy = (c/numComps/numLayers) / numSubpicsX
        subpic_id = sy * numSubpicsX + sx
        channel_id = fm_channel_id[layer_id][c%numComps][subpic_id]
        qF[y][x][channel_id] = subSamples[y + sy * subPicH][x + sx *
subPicW][c%3] of subChannelID
    }
  }
}
```

The inverse channel pack unit 3021 may perform the above processing in a case that fm_param_flag is 1.

In a case that fm_param_flag=0 and fm_channel_id is not present, the header decoder 3031 may derive the correspondence information fm_channel_id from the layer ID subChannelID and the sub-picture ID subpic_id in c=0 . . . . C2-1.

$$numComps = 3$$

$$subChannelID = c / ( numComps * numSubpics )$$

$$sx = ( c / numComps ) \% numSubpicsX$$

$$sy = ( c / numComp ) / numSubpicsX$$

$$subpic\_id = sy * numSubpicsX + sx$$

$$fm\_ channel\_id [ subChannelID ] [ c \% numComps ] [ subpic\_id ] = c$$

In a case of being assigned to multiple 4:4:4 format videos illustrated in FIG. 7(a), the inverse channel pack unit 3021 reconstructs the feature map including 64 channels illustrated in FIG. 6(b). For example, the feature map is reconstructed from component Y of sub-channel 0, component U of sub-channel 0, component V of sub-channel 0, component Y of sub-channel 1, component U of sub-channel 1, component V of sub-channel 1, . . . , component Y of sub-channel 21.

In a case that the sub-channels are assigned to multiple 4:2:0 format videos illustrated in FIG. 7(b), the inverse channel pack unit 3021 reconstructs the feature map assigned to components U and V by upsampling to a double in both of the horizontal direction and the vertical direction.

In a case that the sub-channels are assigned to multiple 4:4:4 format videos illustrated in FIG. 8(a), the inverse channel pack unit 3021 reconstructs the feature map including 64 channels illustrated in FIG. 6(b). For example, the feature map is reconstructed from component V of sub-channel 0, component Y of sub-channel 1, component U of sub-channel 1, component V of sub-channel 1, . . . , component Y of sub-channel 21, component U of sub-channel 21, and component V of sub-channel 21.

In a case that the sub-channels are assigned to multiple 4:2:0 format videos illustrated in FIG. 8(b), the inverse channel pack unit 3021 reconstructs the feature map assigned to components U and V by upsampling to a double in both of the horizontal direction and the vertical direction. The inverse quantization unit 3022 inversely quantizes the quantized feature map qF, and outputs the feature map represented in a 32-bit floating-point number as the decoded feature map Fd.

The decoded feature map Fd is derived as follows.

$$Fd = ( qF - Offset ) * Scale$$

Here, each parameter is defined as follows.
Fd: Decoded feature map (32-bit floating-point number)
qF: Quantized feature map (10-bit integer)
Offset: Quantization offset value (10-bit integer)
Scale: Quantization scale value

The video decoder 303 has a function of decoding the coding stream that has been coded with VVC/H.266, HEVC/H.265, or the like, and decodes the coding stream Te and outputs as the decoded image Td.

The image analyzing apparatus 51 performs analysis processing such as object detection, object segmentation, and object tracking, using the decoded feature map Fd obtained by decoding the coding stream Fe.

In a case that the feature map is assigned to sub-pictures and coded, the header decoder 3031 performs decoding of the coded data in which sps_independent_subpics_flag=1 or the specific sub-picture i assigned with the feature map is coded as sps_independent_subpics_flag[i]=1. In other words, the video of the feature map is decoded, which is allowed to be independently decoded without reference among the sub-pictures in prediction image generation, a loop filter, and the like.

As described above, an aspect of the present invention has a configuration in which the feature map is packed into multiple sub-channels including three components and coded. Therefore, owing to coding tools of intra prediction using correlation among color components and inter prediction using the same motion vector among color components in the coding schemes, the feature map can be efficiently coded and decoded, with correlation of channels being taken into consideration. By allowing independent decoding of the sub-pictures and performing padding outside the picture at the sub-picture boundary, an unnecessary error can be prevented from occurring among the sub-pictures, and prediction efficiency can be enhanced. The channels of each feature map assigned to the sub-pictures can be decoded in parallel.

### Configuration of Image Coding Apparatus According to Second Embodiment

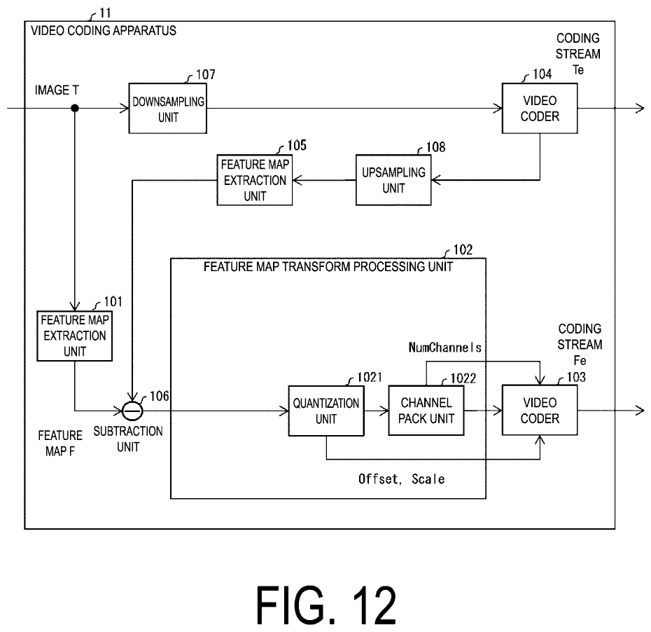

FIG. 12 is a functional block diagram illustrating a schematic configuration of the video coding apparatus 11 according to a second embodiment. The video coding apparatus 11 of the present configuration derives coded data (first coded data, a base layer) of the image and coded data (second coded data, an enhancement layer) of the feature map, and outputs as two pieces of coded data. It is a configuration of deriving a difference value of the coded data of the feature map from the coded data of the image by using so-called hierarchical coding, and is characterized in using downsampling in derivation of the coded data.

The video coding apparatus 11 includes a feature map extraction unit 101, a feature map transform processing unit 102, a video coder 103, a video coder 104, a feature map extraction unit 105, a subtraction unit 106, a downsampling unit 107, and an upsampling unit 108.

Functional blocks similar to those of the first embodiment are denoted by the same reference signs and description thereof will be omitted.

A difference from the video coding apparatus 11 according to the first embodiment lies in inclusion of the feature map extraction unit 105, the subtraction unit 106, the downsampling unit 107, and the upsampling unit 108.

The downsampling unit 107 downsamples and outputs the image T.

The upsampling unit 108 upsamples and outputs a locally decoded image output from the video coder 104.

The feature map extraction unit 105 inputs the locally decoded image output from the upsampling unit 108, and outputs the feature map FdBase as a base, similarly to the feature map extraction unit 101.

The subtraction unit 106 outputs the difference feature map FdResi being a difference between the feature map of a source image input from the feature map extraction unit 101 and the feature map of the locally decoded image input from the feature map extraction unit 105.

As described above, the present application has the following configuration: the image obtained by downsampling the source image is coded as the first coded data, and the difference between the feature map obtained from the image obtained by upsampling the locally decoded image of the coded image and the feature map of the source image is coded as the second coded data. This can reduce the amount of information of the coding stream Te necessary for coding of the feature map.

### Configuration of Image Decoding Apparatus According to Second Embodiment

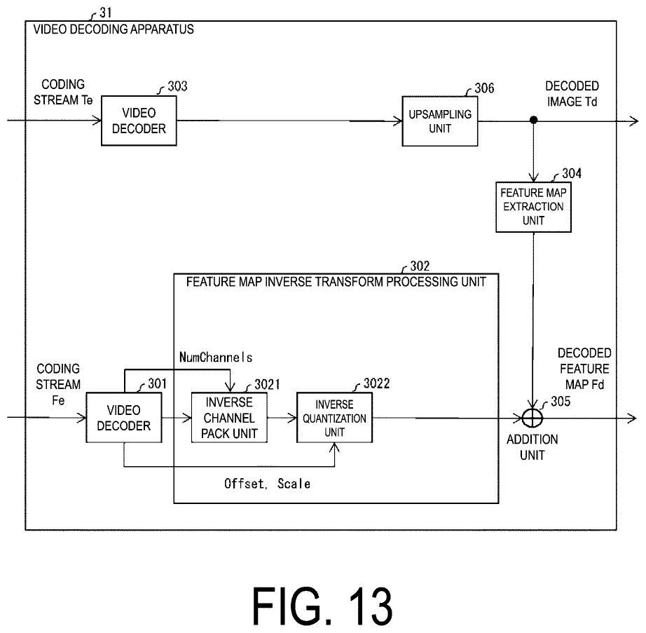

FIG. 13 is a functional block diagram illustrating a schematic configuration of the video decoding apparatus 31 according to the second embodiment. The video decoding apparatus 31 of the present configuration decodes coded data (first coded data) of the image and coded data (second coded data) of the feature map coded as a difference value, and derives the feature map. Here, it is characterized in using an upsampled image of the decoded image.

The video decoding apparatus 31 includes a video decoder 301, a feature map inverse transform processing unit 302, a video decoder 303, a feature map extraction unit 304, an addition unit 305, and an upsampling unit 306.

Functional blocks similar to those of the first embodiment are denoted by the same reference signs and description thereof will be omitted.

A difference from the video decoding apparatus 31 according to the first embodiment lies in inclusion of the feature map extraction unit 304, the addition unit 305, and the upsampling unit 306.

The upsampling unit 306 upsamples the decoded image output from the video decoder 303, and outputs as the decoded image Td.

The feature map extraction unit 304 inputs the decoded image Td output from the upsampling unit 306, and outputs the feature map FdBase as a base, similarly to the feature map extraction unit 101.

The addition unit 305 adds the difference feature map FdResi input from the feature map inverse transform processing unit 302 and the feature map FdBase of the decoded image input from the feature map extraction unit 304, and outputs the decoded feature map Fd.

The image analyzing apparatus 51 performs analysis processing such as object detection, object segmentation, and object tracking, using the decoded feature map Fd obtained by decoding the coding streams Te and Fe.

As described above, the present application has the following configuration: the first coded data for obtaining a downsampled image is decoded, the difference between the feature map obtained from the image obtained by upsampling the decoded image and the feature map obtained by decoding the second coded data is added, and the feature map is derived. This can reduce the amount of information of the coding stream Te necessary for generation of the decoded feature map Fd.

### Configuration of Image Coding Apparatus According to Third Embodiment

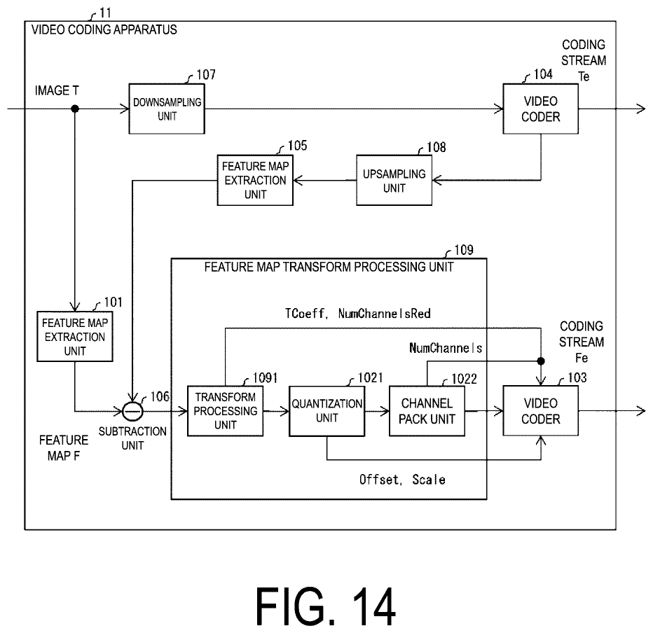

FIG. 14 is a functional block diagram illustrating a schematic configuration of the video coding apparatus 11 according to a third embodiment.

The video coding apparatus 11 includes a feature map extraction unit 101, a feature map transform processing unit 109, a video coder 103, a video coder 104, a feature map extraction unit 105, a subtraction unit 106, a downsampling unit 107, and an upsampling unit 108.

The feature map transform processing unit 109 includes a transform processing unit 1091, a quantization unit 1021, and a channel pack unit 1022.

Functional blocks similar to those of the first and second embodiments are denoted by the same reference signs and description thereof will be omitted.

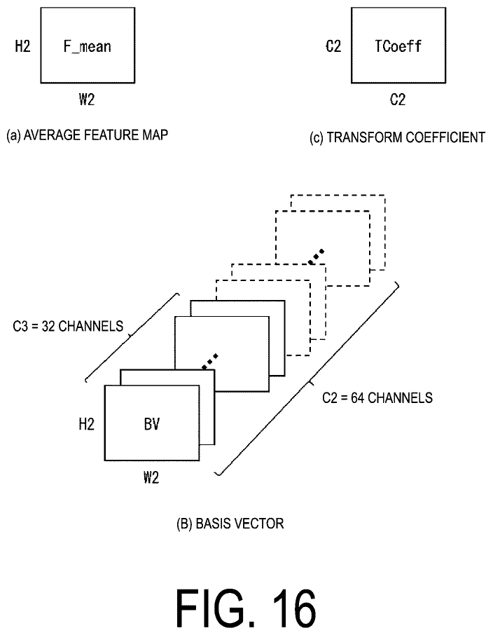

A difference from the video coding apparatus 11 according to the second embodiment is in that the feature map transform processing unit 109 includes the transform processing unit 1091. The transform processing unit 1091 performs transform with Principal Component Analysis (PCA) and performs dimensionality reduction for the feature map. FIG. 16 is a diagram for illustrating operation of the transform processing unit 1091. The transform processing unit 1091 derives an average feature map F_mean (FIG. 16(a)), C2 basis vectors BV (FIG. 16(b)), and a transform coefficient TCoeff (FIG. 16(c)) of C2×C2 in PCA. Next, the average feature map F_mean and C3 (<C2) basis vectors BV are output to the quantization unit 1021 as a feature map F_red after dimensionality reduction. C3×C2 transform coefficients corresponding to the number C3 of channels and the output basis vectors after dimensionality reduction are signaled to the video coder 103.

In general, transform of PCA is represented by a product of a matrix A and an input vector, and inverse transform of PCA is represented by a product of a transposed matrix A and an input vector. The following processing may be performed.

The transform processing unit 1091 performs transform using a transform matrix transMatrix[ ][ ] on a one-dimensional array u[ ] having length of C2, and derives a coefficient v[ ] of the one-dimensional array having length of C3 (C2<C3) as output.

$$v [ i ] = Clip 3 ( CoeffMin , CoeffMax , \sum ( transMatrix [ i ] [ j ] * u [ j ] + 64 ) >> 7 )$$

Here, Σ is a sum of j=0 . . . . C2-1. With i, processing is performed on 0 . . . . C3-1. CoeffMin and CoeffMax indicate a range of transform coefficient values.

The quantization unit 1021 quantizes the feature map F_red (the average feature map F_mean and the basis vectors BV) after dimensionality reduction output from the transform processing unit 1091, and outputs a quantized feature map qF_red (a quantized average feature map qF_mean and quantized basis vectors qBV).

$$qF\_red = Offset + Round ( F\_red / Scale )$$

$$qF\_mean = Offset + Round ( F\_mean / Scale )$$

$$qBV = Offset + Round ( BV / Scale )$$

Here, each parameter is defined as follows.
F_red: Feature map after dimensionality reduction
F_mean: Average feature map
BV: Basis vector
qF_red: Quantized feature map after dimensionality reduction
qF_mean: Quantized average feature map
qF_BV: Quantized basis vector
Offset: Quantization offset value (10-bit integer)
Scale: Quantization scale value

Although the average feature map F_mean and the basis vectors BV are quantized using the same quantization offset value and quantization scale value in the example described above, those may be quantized using different quantization offset values and quantization scale values.

The channel pack unit 1022 packs qF_red into multiple sub-channels including three components (for example, luminance Y and chrominances U and V) and then outputs.

In a case that the number of channels of the basis vectors BV after dimensionality reduction is represented by numChannelsRed, the number numSubChannels of sub-channels output by the channel pack unit 1022 is represented as follows.

$$numSubChannels = Ceil ( ( 1 + numChannelsRed ) \div 3 )$$

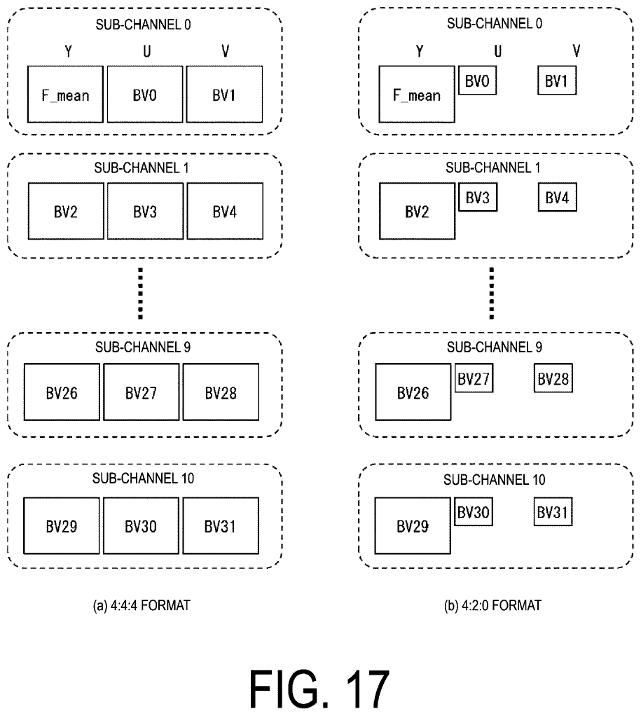

FIG. 17 is a diagram for illustrating examples of channel packs.

FIG. 17(a) is an example in which the channels of the feature map are assigned to multiple 4:4:4 format videos. numChannelsRed is 32. numSubChannels is numSubChannels=Ceil ((1+32)/3)=11.

The channels (F_mean, BV0, BV1, . . . , BV31) of the feature map may be scanned and assigned so that order of the channels is as follows: an outer loop is in order of sub-channels and an inner loop is in order of components. In other words, F_mean is assigned to component Y of sub-channel 0, BV0 is assigned to component U of sub-channel 0, BV1 is assigned to component V of sub-channel 0, BV2 is assigned to component Y of sub-channel 1, BV3 is assigned to component U of sub-channel 1, BV4 is assigned to component V of sub-channel 1, and so on.

FIG. 17(b) is an example in which the channels of the feature map are assigned to multiple 4:2:0 format videos. The channel pack unit 1022 downsamples the feature map to ½ in both of the horizontal direction and the vertical direction and assigns to components U and V.

The video coder 103 codes the feature map information including NumChannelsRed and TCoeff output from the transform processing unit 1091 as the supplemental enhancement information SEI, and outputs as the coding stream Fe.

FIG. 18(c) is a diagram illustrating an example of the syntax of the feature map information. Semantics of each field is as follows.
fm_quantization_offset: Quantization offset value Offset
fm_quantization_scale: Quantization scale value Scale
fm_num_channels_minus1: fm_num_channels_minus1+1 indicates the number numChannels of channels of the feature map.
fm_transform_flag: Flag indicating whether transform is required or not.
fm_num_channels_red_minus1: fm_num_channels_red_minus1+1 indicates the number numChannelsRed of channels of the basis vectors BV after dimensionality reduction.
fm_transform_coefficient[i][j]: (i, j) component of the transform coefficient TCoeff (32-bit floating-point number)

Alternatively, the feature map information may be signaled using the sequence parameter set SPS or the picture parameter set PPS, similarly to the first and second embodiments.

### Configuration of Image Decoding Apparatus According to Third Embodiment

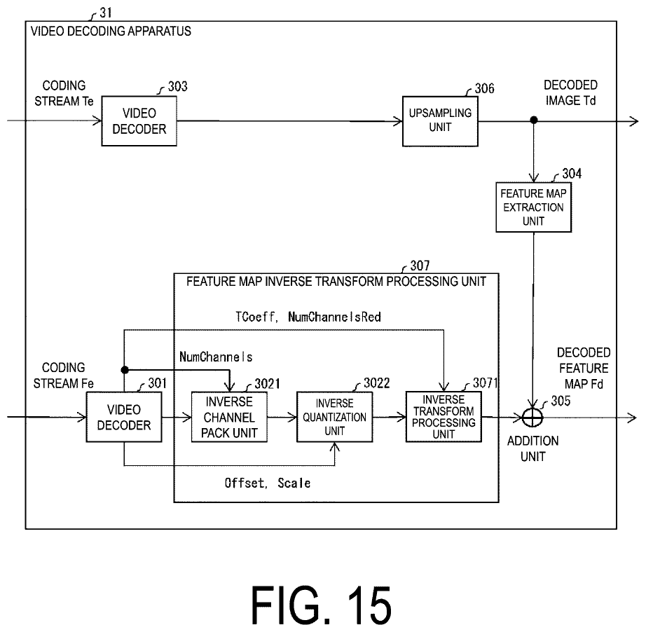

FIG. 15 is a functional block diagram illustrating a schematic configuration of the video decoding apparatus 31 according to the third embodiment.

The video decoding apparatus 31 includes a video decoder 301, a feature map inverse transform processing unit 307, a video decoder 303, a feature map extraction unit 304, an addition unit 305, an upsampling unit 306, and an upsampling unit 307.

The feature map inverse transform processing unit 307 includes an inverse channel pack unit 3021, an inverse quantization unit 3022, and an inverse transform processing unit 3071.

Functional blocks similar to those of the first and second embodiments are denoted by the same reference signs and description thereof will be omitted.

A difference from the video decoding apparatus 31 according to the second embodiment is in that the feature map inverse transform processing unit 307 inclusions the inverse transform processing unit 3071.

The video decoder 301 decodes the feature map supplemental enhancement information SEI included in the coding stream Fe, derives Offset, Scale, numChannels, the flag indicating whether transform is required or not, numChannelsRed, and the transform coefficient, and signals to the feature map inverse transform processing unit 302.

$$Offset = fm\_quantization \_offset$$

$$Scale = fm\_quantization \_scale$$

$$numChannels = fm\_num \_channels \_minus1 + 1$$

$$numChannelsRed = fm\_num \_channels \_red \_minus1 + 1$$

$$TCoeff [ ] [ ] = fm\_transform \_coefficient [ ] [ ]$$

Alternatively, similarly to the first and second embodiments, these values may be derived by decoding the above syntax with the sequence parameter set SPS or the picture parameter set PPS.

The inverse channel pack unit 3021 reconstructs the feature map from multiple sub-channels including three components (for example, luminance Y and chrominances U and V).

In a case that the quantized feature map is assigned to multiple 4:4:4 format videos illustrated in FIG. 17(a), the average feature map and the basis vectors including 32 channels illustrated in FIG. 16 are reconstructed from each component. For example, the average feature map and the basis vectors are reconstructed from component Y of sub-channel 0, component U of sub-channel 0, component V of sub-channel 0, component Y of sub-channel 1, component U of sub-channel 1, component V of sub-channel 1, . . . , component V of sub-channel 10.

In a case that the quantized feature map is assigned to multiple 4:2:0 format videos illustrated in FIG. 17(b), the feature map assigned to components U and V is reconstructed by upsampling to a double in both of the horizontal direction and the vertical direction.

The inverse quantization unit 3022 inversely quantizes qF_red, and outputs Fd_mean and BVd.

$$Fd\_red = ( qF\_red - Offset ) * Scale$$

$$Fd\_mean = ( qF\_mean - Offset ) * Scale$$

$$BVd = ( qBV - Offset ) * Scale$$

Here, each parameter is defined as follows.
Fd red: Decoded feature map before dimensionality reconstruction (32-bit floating-point number)
Fd mean: Decoded average feature map
BVd: Decoded basis vector
qF_red: Quantized feature map before dimensionality reconstruction (10-bit integer)
qF_mean: Quantized average feature map
qBV: Quantized basis vector
Offset: Quantization offset value (10-bit integer)
Scale: Quantization scale value

The inverse transform processing unit 3071 performs inverse transform with principal component analysis using Fd_red and TCoeff, performs dimensionality reconstruction for the feature map, and outputs the decoded feature map Fd.

The image analyzing apparatus 51 performs analysis processing such as object detection, object segmentation, and object tracking, using the decoded feature map Fd obtained by decoding the coding streams Te and Fe.

As described above, coding and decoding are performed with dimensionality of the feature map being reduced using principal component analysis, and therefore the amount of information necessary for coding and decoding of the feature map can be reduced without reducing performance of image analysis processing.

Note that a part of the video coding apparatus 11 and the video decoding apparatus 31 according to the embodiments described above, examples of which include the feature map extraction unit 101, the feature map transform processing unit 102, the video coder 103, the video coder 104, the feature map extraction unit 105, the subtraction unit 106, the downsampling unit 107, the upsampling unit 108, the video decoder 301, the feature map inverse transform processing unit 302, the video decoder 303, the feature map extraction unit 304, the addition unit 305, and the upsampling unit 306, may be implemented by a computer. In that case, this configuration may be realized by recording a program for realizing such control functions on a computer-readable recording medium and causing a computer system to read and perform the program recorded on the recording medium. Further, the “computer system” described here refers to a computer system built into either the video coding apparatus 11 or the video decoding apparatus 31 and is assumed to include an OS and hardware components such as a peripheral apparatus. A “computer-readable recording medium” refers to a portable medium such as a flexible disk, a magneto-optical disk, a ROM, and a CD-ROM, and a storage apparatus such as a hard disk built into the computer system. Moreover, the “computer-readable recording medium” may include a medium that dynamically stores a program for a short period of time, such as a communication line in a case that the program is transmitted over a network such as the Internet or over a communication line such as a telephone line, and may also include a medium that stores the program for a certain period of time, such as a volatile memory included in the computer system functioning as a server or a client in such a case. The above-described program may be one for implementing a part of the above-described functions, and also may be one capable of implementing the above-described functions in combination with a program already recorded in a computer system.

A part or all of the video coding apparatus 11 and the video decoding apparatus 31 in the embodiment described above may be realized as an integrated circuit such as a Large Scale Integration (LSI). Each function block of the video coding apparatus 11 and the video decoding apparatus 31 may be individually realized as processors, or part or all may be integrated into processors. The circuit integration technique is not limited to LSI, and may be realized as dedicated circuits or a multi-purpose processor. In a case that, with advances in semiconductor technology, a circuit integration technology with which an LSI is replaced appears, an integrated circuit based on the technology may be used.

Although the embodiments of the present invention have been described in detail above referring to the drawings, the specific configuration is not limited to the above embodiment, and various amendments can be made to a design that fall within the scope that does not depart from the gist of the present invention.

The embodiments of the present invention are not limited to the above-described embodiments, and various modifications can be made within the scope of the claims. That is, an embodiment obtained by combining technical means modified appropriately within the scope of the claims is also included in the technical scope of the present invention.

### INDUSTRIAL APPLICABILITY

The embodiments of the present invention can be preferably applied to a video decoding apparatus that decodes coded data in which image data is coded, and a video coding apparatus that generates coded data in which image data is coded. Furthermore, the embodiments of the present invention can be preferably applied to a data structure of coded data generated by the video coding apparatus and referred to by the video decoding apparatus.

1. A video coding apparatus for coding a feature map, the video coding apparatus comprising:
a quantization circuit that quantizes the feature map;
a channel pack circuit that packs the feature map into multiple sub-channels, each including three components; and
a first video coder that codes a sub-channel of the multiple sub-channels, wherein
the first video coder codes a quantization offset value and/or a quantization scale value.

2. The video coding apparatus according to claim 1, further comprising
a second video coder that codes an image, wherein
the feature map is difference data between a feature map of the image and a feature map of a locally decoded image.

3. The video coding apparatus according to claim 1, further comprising
a second video coder that codes an image, wherein
the feature map is difference data between a feature map of the image and a feature map obtained by upsampling a feature map of a locally decoded image obtained by downsampling the image and then coding the downsampled image.

4. The video coding apparatus according to claim 1, further comprising
a transform processing circuit that reduces dimensionality of the feature map.

5. A video decoding apparatus for decoding a feature map from a coding stream, the video decoding apparatus comprising:
a first video decoder that decodes multiple sub-channels, each including three components, from the coding stream;
an inverse channel pack circuit that reconstructs a feature map from a sub-channel of the multiple sub-channels; and
an inverse quantization circuit that inversely quantizes the feature map, wherein
the first video decoder decodes a quantization offset value and/or a quantization scale value.

6. The video decoding apparatus according to claim 5, further comprising
a second video decoder that decodes an image from a coding stream of an image, wherein
the feature map is data obtained by adding the inversely quantized feature map and a feature map of the image.

7. The video decoding apparatus according to claim 5, further comprising
a second video decoder that decodes an image, wherein
the feature map is data obtained by adding the inversely quantized feature map and a feature map obtained by upsampling the feature map of the image.

8. The video decoding apparatus according to claim 5, further comprising
an inverse transform processing circuit that reconstructs dimensionality of the feature map.

9. (canceled)

10. A video decoding method of decoding a feature map from a coding stream, the video decoding method at least comprising the steps of:
decoding multiple sub-channels, each including three components, from the coding stream;
reconstructing a feature map from a sub-channel of the multiple sub-channels; and
inversely quantizing the feature map, wherein
the decoding includes decoding a quantization offset value and/or a quantization scale value.
